(19) United States
(12) Patent Application Publication
(10) Pub. No.: US 2016/0117300 A1
(43) Pub. Date: Apr. 28, 2016

(54) SYSTEM, METHOD, AND RECORDING MEDIUM

(71) Applicant: FUJITSU LIMITED, Kawasaki-shi (JP)

(72) Inventors: Koki HATADA, Kawasaki (JP); Katsuhiko AKIYAMA, Kawasaki (JP)

(73) Assignee: FUJITSU LIMITED, Kawasaki-shi (JP)

(21) Appl. No.: 14/924,331

(22) Filed: Oct. 27, 2015

(30) Foreign Application Priority Data
Oct. 27, 2014 (JP) 2014-218728

(51) Int. Cl. G06F 17/24; G06F 17/30

(52) U.S. Cl. CPC G06F 17/24; G06F 17/30575; G06F 17/30572; G06F 17/30011

(57) ABSTRACT

A system includes circuitry configured to: input first operation information to perform first operation to an object data at first terminal, the object data being operable by second terminal; acquire second operation information to perform second operation to the object data at the second terminal; determine whether second display data of the second operation is to be displayed, based on the first operation information and the second operation information when the first operation and the second operation do not conflict; and output to a display interface the second display data of the second operation along with first display data of the first operation when the second display data is determined to be displayed.

### CROSS-REFERENCE TO RELATED APPLICATION

This application is based upon and claims the benefit of priority of the prior Japanese Patent Application No. 2014-218728, filed on Oct. 27, 2014, the entire contents of which are incorporated herein by reference.

### FIELD

The embodiment discussed herein is related to a system, a method, and a recording medium.

### BACKGROUND

There are techniques to allow a plurality of terminals to operate identical data at the same time via a network. Techniques by which two terminal devices edit an identical object at the same time in remote cooperative working support systems that share data objects have been proposed as the related art.

Another techniques related to shared information model operation have been proposed, by which when a shared information model is operated, one performs operation for his or her personal trials and errors on the shared information model without hindering operation of another person who works together.

Another techniques have been proposed, by which when change in a range of an image that a screen includes is synchronized among a plurality of information processors, the change process is reserved when certain conditions are satisfied, or the change process is performed when such certain conditions are unsatisfied or become unsatisfied.

Still another techniques related to exclusive operation control have been proposed, through which when input operations of a plurality of users conflict, contents that reflect both of the input operations are displayed instead of performing only one of the input operations.

When one or more of a plurality of terminals operate data, synchronization is performed on the data among the plurality of terminals. When the synchronization of the data is performed while a terminal user is performing operation on an object using his or her own terminal, operation at another terminal is reflected in the object that the user is operating.

This operation is the operation that the user has not performed or expected. Accordingly, the operability of the user in operating the object is decreased by the operation performed at the terminal other than the user's terminal.

Examples of the related art include Japanese Laid-open Patent Publication No. 2007-280147, Japanese Laid-open Patent Publication No. 6-266641, Japanese Laid-open Patent Publication No. 2011-134122, and International Publication Pamphlet No. WO 2010/035476.

### SUMMARY

According to an aspect of the invention, a system includes circuitry configured to: input first operation information to perform first operation to an object data at first terminal, the object data being operable by second terminal; acquire second operation information to perform second operation to the object data at the second terminal; determine whether second display data of the second operation is to be displayed, based on the first operation information and the second operation information when the first operation and the second operation do not conflict; and output to a display interface the second display data of the second operation along with first display data of the first operation when the second display data is determined to be displayed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a system according to an embodiment;

FIG. 2 illustrates an example of the system in a case in which the system includes no server;

FIG. 3 is a function block diagram illustrating an example of a terminal;

FIG. 4 is a flow chart illustrating an example of a synchronization process;

FIG. 5 illustrates an example of operation that influences operability;

FIG. 6 illustrates a first specific example of an operation support process;

FIG. 7 illustrates a second specific example of the operation support process;

FIG. 8 illustrates a third specific example of the operation support process;

FIG. 9 is a diagram for explaining an example in which operation is abandoned;

FIG. 10 is a flow chart illustrating an example of the operation support process;

FIG. 11 illustrates an example of a table stored in a storage unit;

FIG. 12 illustrates examples of relations among object IDs, attributes and values;

FIGS. 13 and 14 each illustrate an example of temporal transition of the operation support process; and

FIG. 15 illustrates an example of a hardware configuration of an operation support device.

### DESCRIPTION OF EMBODIMENT

According to an aspect of an embodiment of the present application, operability in operating data synchronized among a plurality of terminals may be enhanced.

[Example of Overall Configuration of System]

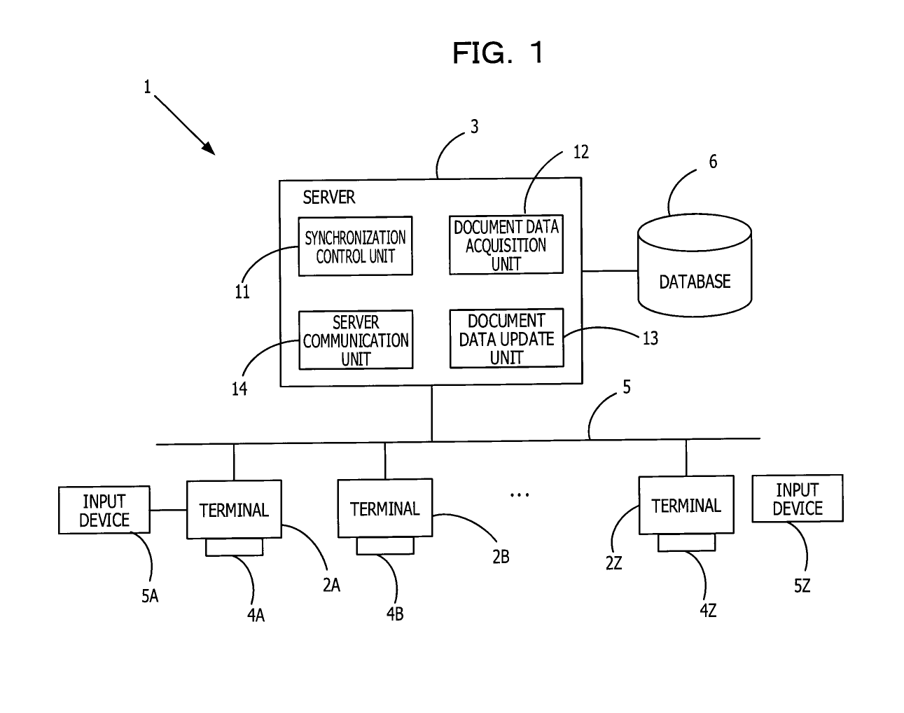

An embodiment is described below with reference to the drawings. FIG. 1 illustrates an example of a system 1 according to the embodiment. The system 1 includes a plurality of terminals 2A to 2Z, which may be hereinafter referred to simply as the terminals 2, and includes a server 3. The system 1 in FIG. 1 is an example and the system 1 is not limited to the example in FIG. 1.

A given information processor may be applied as the terminal 2. For example, a personal computer, a television, a projector, a head mount display, a smartphone, or a tablet terminal may be applied as the terminal 2. The terminal 2 is an example of an operation support device.

Display devices 4A to 4Z, which may be hereinafter referred to simply as the display devices 4, are coupled to the terminals 2A to 2Z, respectively. An input device 5A is coupled to the terminal 2A. A user who operates the terminal 2A uses the input device 5A to operate the terminal 2A.

No input device is coupled to the terminal 2B. For example, when the display device 4B is a touch panel display, the display device 4B functions as an input device. Short-distance radio communication is possible between the terminal 2Z and an input device 5Z. A user uses the input device 5Z to operate the terminal 2Z. The input devices corresponding to the respective terminals 2 may be hereinafter referred to simply as the input devices 5.

The number of the terminals 2 included in the system 1 may be a given number that is two or more. The relations among the terminals 2, the display devices 4, and the input devices 5 are not limited to the example in FIG. 1.

Each terminal 2 and the server 3 are coupled via a network 5. The network 5 may be for example, a local area network (LAN). The network 5 is not limited to the LAN. Another example of the network 5 may be a dedicated line.

A database 6 is coupled to the server 3. In the embodiment, the database 6 stores document data concerning a document. The database 6 stores one or more pieces of document data. The document data is an example of data. The data may be data other than such document data. For example, the data may be data on a web page, a still image, a moving image, or a computer-aided design (CAD).

The server 3 includes a synchronization control unit 11, a document data acquisition unit 12, a document data update unit 13, and a server communication unit 14. The synchronization control unit 11 controls synchronization of the document data stored in the plurality of terminals 2.

The document data acquisition unit 12 acquires certain document data from the database 6. The document data update unit 13 updates the contents of certain document data stored in the database 6. The server communication unit 14 communicates with each terminal 2.

The document data acquisition unit 12 acquires document data in accordance with a request of each terminal 2 from the database 6. The document data update unit 13 updates or deletes document data in the database 6 in accordance with a request from each terminal 2.

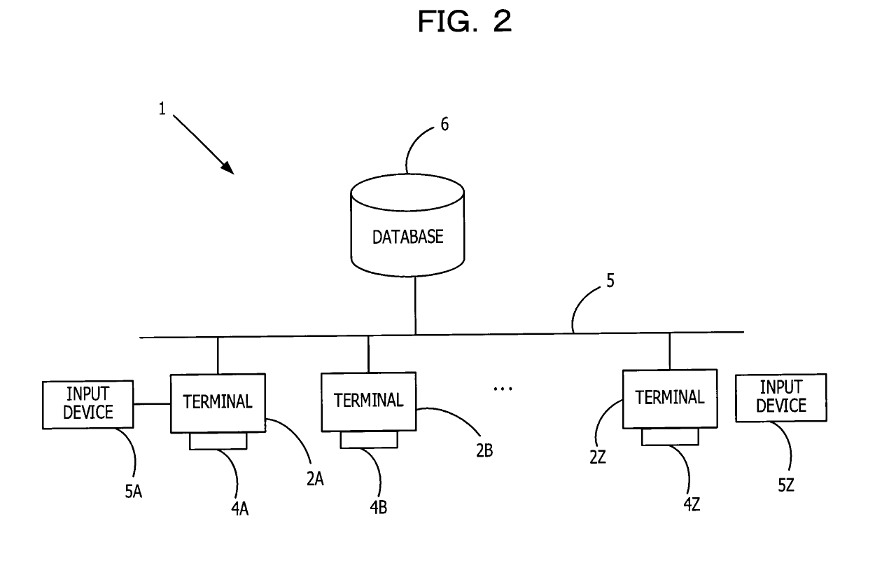

The system 1 may omit the server 3. FIG. 2 illustrates an example of the system 1 in a case in which the server 3 is not included in the system 1. In the example in FIG. 2, the database 6 is coupled to the network 5. In this case, any one of the terminals 2 has the function of each unit in the server 3 in FIG. 1.

Each terminal 2 may acquire document data from the database 6 via the network 5. Further, each terminal 2 may update the document data stored in the database 6 via the network 5.

[Example of Terminal]

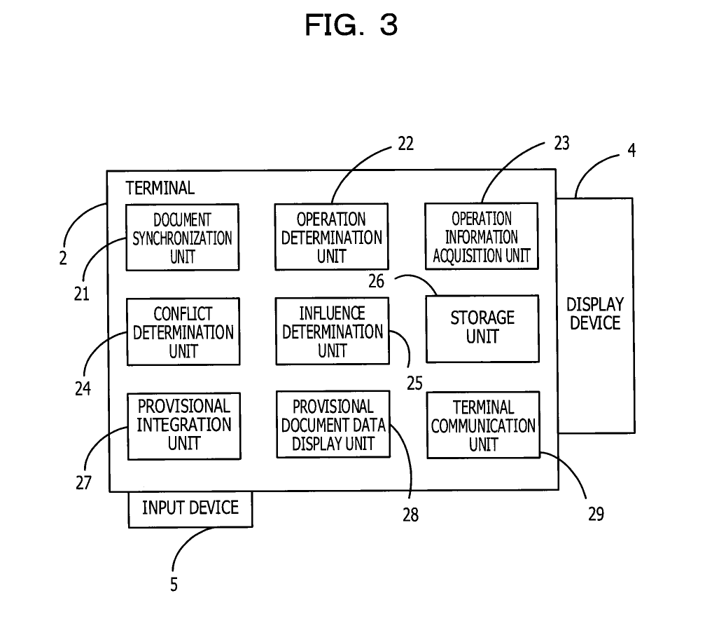

FIG. 3 illustrates an example of the terminal 2. The display device 4 and the input device 5 are coupled to the terminal 2 in FIG. 3. The display device 4 is coupled to the terminal 2 via display interface (not illustrated) in

FIG. 3. The display device 4 is an example of a display unit. The terminal 2 includes a document synchronization unit 21, an operation determination unit 22, an operation information acquisition unit 23, a conflict determination unit 24, an influence determination unit 25, a storage unit 26, a provisional integration unit 27, a provisional document data display unit 28, and a terminal communication unit 29.

Description may be presented below while assuming that the number of the terminals 2 is two. The terminal 2A is the terminal 2 operated by a user, which is the terminal 2 of the user's own and hereinafter referred to as the own terminal 2. The terminal 2B is the terminal 2 operated by another user. In a case in which the number of the terminals 2 is three or more, the terminal 2A serves as the own terminal 2, and the two or more terminals 2 except the terminal 2A serve as the other terminal 2.

The document synchronization unit 21 synchronizes document data of the own terminal 2 and document data of the other terminal 2. The document synchronization unit 21 synchronizes the document data by requesting the synchronization control unit 11 of the server 3. The synchronization control unit 11 of the server 3 synchronizes the document data of each terminal 2 in response to the request from the document synchronization unit 21. As a result, the document data may be consistent with each other between the terminals 2. The document synchronization unit 21 is an example of a synchronization unit.

When the server 3 is not included in the system 1 as illustrated in the example in FIG. 2, the document synchronization unit 21 synchronizes the document data by requesting the terminal 2 that has the function of the synchronization control unit 11.

When the document data are synchronized, communication is performed between the terminals 2 or between the terminal 2 and the server 3. The communication method is not particularly limited. In the embodiment, although the synchronization control unit 11 controls the synchronization of the document data, the communication method is not limited to this example.

The operation determination unit 22 determines whether or not the document data of the terminal 2 is being edited. The document data includes one or more objects. The object in the document data is data that may be operated. The operation determination unit 22 determines whether or not operation is being performed on an object included in the document data. Editing for the object included in the document data is an example of the operation.

The object is data made up as one unit. The object included in the document data may be given data. For example, the object may be a tag added to a document, a paragraph of sentences, an image, a table, a cell of a table, a text box, or a figure.

The object includes an attribute. Examples of the attribute of the object include contents, a format, a position, and a size of the object. For example, the operation determination unit 22 may determine whether or not the document data is being edited in accordance with conditions related to the status, such as a cursor position, character input, a click, or a touch with respect to the object.

For example, the operation determination unit 22 may determine that the document data is being edited when dragging operation is being performed on the object. Further, the operation determination unit 22 may determine that the document data is being edited when time elapsed after selection of the object is within certain time.

When time elapsed after character input or character deletion has been performed on the object is within certain time, the operation determination unit 22 may determine that the document data is being edited. Further, the operation determination unit 22 may determine that the document data is being edited when time elapsed after change in the format of the object is within certain time.

When operation is being performed on one or more objects included in the document data, the operation determination unit 22 identifies the objects on which the operation is being performed. The operation for the object is performed by the input device 5. Thus, the operation determination unit 22 may identify the object in accordance with the operation performed by the input device 5.

In the embodiment, when operation is being performed on one or more objects, the operation determination unit 22 identifies which of the objects is undergoing the operation. The operation determination unit 22 may omit the identifying function, which may be provided separately.

The operation information acquisition unit 23 acquires information that indicates the content of the operation performed by the other terminal 2B when while the terminal 2A of the user is operating document data, the terminal 2B is operating the identical document data. The information is referred to as the operation information. The operation information includes the information on the operated object and the content that indicates the operation performed on the object.

The above-described identical document data indicate logically identical document data. The terminal 2A and the terminal 2B are different devices, and the document data of the terminal 2A and the document data of the terminal 2B are physically different.

The document data of the terminal 2A and the document data of the terminal 2B are synchronized by the document synchronization unit 21 and the synchronization control unit 11 of the server 3, and are logically identical document data. Hereinafter, the document data that are logically identical are referred to as the identical document data even when the document data are physically different.

The operation that the terminal 2A of the user performs on the document data is referred to as the first operation, and the operation that the other terminal 2B performs on the document data synchronized with the document data of the terminal 2A is referred to as the second operation. The information on the first operation is referred to as the first operation information, and the information on the second operation is referred to as the second operation information.

When the own terminal 2A and the other terminal 2B operate identical objects, the conflict determination unit 24 determines compatibility of the operations. In other words, the conflict determination unit 24 determines whether or not the operations are conflicting. For example, the operation results depend on the order of the operations on the identical objects, it may be determined that that the operations are conflicting. Similar to the above-described document data, the identical objects indicate logically identical objects.

For example, when the own terminal 2A and the other terminal 2B perform operations to change the color of the identical objects at the same time, on the assumption that the color changed by the terminal that ends the operation later is employed, the results of the color change vary, depending on the order of changing the color of the own terminal 2A and the other terminal 2B. In this case, the conflict determination unit 24 determines that the operations are conflicting.

On the above-described assumption, when the operations conflict, the operation performed on the object earlier is disabled. Accordingly, the efficiency of the operation on the object may decrease.

In contrast, even when the own terminal 2A and the other terminal 2B operate identical objects at the same time, there is a case in which the operations do not conflict. For example, when the own terminal 2A changes the position of the object while the other terminal 2B changes the color of the identical object, the results of the operations are identical regardless of the operation orders, and the operations do not conflict.

An object includes a plurality of attributes. In the above-described case, the position and color of the object are different attributes and the attributes are independent of each other. Thus, even when the own terminal 2A and the other terminal 2B perform the position changing operation and the color changing operation on the identical objects, the operations do not conflict. With regard to the operations on the attributes that are different and independent, the conflict determination unit 24 determines that the operations do not conflict.

When there is no conflict between operations and identical document data are operated by the terminal 2A and the other terminal 2B at the same time, the influence determination unit 25 determines whether or not the operations of the terminal 2A and the other terminal 2B are influenced in their operability.

When there is no conflict between operations, the plurality of terminals 2 may operate an identical object at the same time. In this case, since the own terminal 2A and the other terminal 2B operate the identical objects at the same time, the operability may decrease. In contrast, depending on the operation performed on the object, even when the identical objects are operated at the same time, no influence may be caused on the operability.

When identical objects are operated by the own terminal 2A and the other terminal 2B at the same time in accordance with the first operation information of the own terminal 2A and the second operation information of the other terminal 2B, the influence determination unit 25 determines whether or not the operability is influenced.

The storage unit 26 stores various kinds of information. The storage unit 26 stores a table (attribute information). The table indicates the presence or absence of influence on operability and the presence or absence of a conflict for each combination of the first operation information and the second operation information. The conflict determination unit 24 determines the presence or absence of a conflict of operations by referring to the table stored in the storage unit 26. The influence determination unit 25 determines the presence or absence of influence on operability by referring to the table stored in the storage unit 26. The storage unit 26 stores another information in addition to the table. For example, the storage unit 26 may store document data.

The provisional integration unit 27 determines whether or not the operation information of the other terminal 2B is applied to the document data of the own terminal 2A in accordance with the determination result of the influence determination unit 25. When the influence determination unit 25 determines that the operability is influenced, the provisional integration unit 27 applies the operation indicated by the second operation information of the other terminal 2B to the resultant document data after replicating all or part of document data. Hereinafter, the resultant document data after the replication to which the operation indicated by the operation information of the other terminal 2B is applied is referred to as provisional document data.

The provisional integration unit 27 applies the second operation information to the provisional document data. When the operation determination unit 22 determines that no operation is being performed at the own terminal 2, the provisional integration unit 27 erases the provisional document data to which the second operation information is applied.

The provisional document data display unit 28 causes the provisional document data to be displayed on the screen of the display device 4 in a manner different from the display of the part being operated while maintaining the display of the part being operated at the own terminal 2A. When the provisional integration unit 27 erases the provisional document data to which the second operation information is applied, the provisional document data display unit 28 causes the provisional document data to be undisplayed.

For example, the provisional document data display unit 28 may cause the display device 4 to display the provisional document data by changing the transparency, hues, or the like of the second operation information. For example, when the second operation information of the other terminal 2B is information that indicates the operation for an object, the provisional document data display unit 28 may cause the display device 4 to display the provisional document data by raising the transparency of the target object of the operation indicated by the second operation information.

The provisional integration unit 27 may apply the operation indicated by the second operation information to the provisional document data in a manner different from the display of the part being operated at the own terminal 2A. After that, the provisional document data display unit 28 may cause the provisional document data to be displayed.

The provisional document data display unit 28 may perform superimposition display by superimposing the provisional document data on the object being operated at the own terminal 2A while maintaining the display of the object. In this case, the object being operated at the terminal 2A and the replica of the object being operated at the other terminal 2B are displayed on the display device 4 in different manners. As a result, the user who is operating the terminal 2A may visually recognize that the identical object has been operated at the other terminal 2B.

When the provisional document data display unit 28 performs the above-described superimposition display, the object being operated at the terminal 2A and the replica of the object being operated in the other terminal 2B may overlap. In this case, viewability decreases. Thus, the provisional document data display unit 28 may shift the position of the superimposition display or may enlarge or reduce the object.

Further, the provisional document data display unit 28 may divide the screen of the display device 4 and cause the provisional document data to be displayed on a partial region obtained after the division. The provisional document data display unit 28 may cause the document data of the own terminal 2 to be displayed on another region.

The provisional document data display unit 28 may enlarge, reduce, or move the partial region obtained after the division of the screen. Further, the provisional document data display unit 28 may divide the screen of the display device 4 into right and left parts or upper and lower parts, or may cut out part of the screen.

When the display device 4 includes a plurality of screens, the document data of the own terminal 2 may be displayed on one of the screens and the provisional document data may be displayed on another one of the screens. The provisional document data display unit 28 may cause the screen of the display device 4 to display not only the provisional document data but also additional information based on the second operation information.

For example, as a result of applying the second operation information to the provisional document data, the target object of the operation indicated by the second operation information may move out of the region of the screen of the display device 4. In this case, the provisional document data display unit 28 may cause the screen of the display device 4 to display character information that indicates that the object has been moved out of the screen. The provisional document data display unit 28 may cause the character information to be displayed by, for example, relating information on the editor who has performed the operation indicated by the second operation information to the object.

The terminal communication unit 29 performs communication with the other terminal 2 and the server 3 via the network 5. The terminal 2 is not limited to the example in FIG. 3, and may include another element. As described above, the input device 5 may perform short-distance radio communication with the terminal 2, and the display device 4 and the input device 5 may be an integrated touch panel display.

[Example of Synchronization Process]

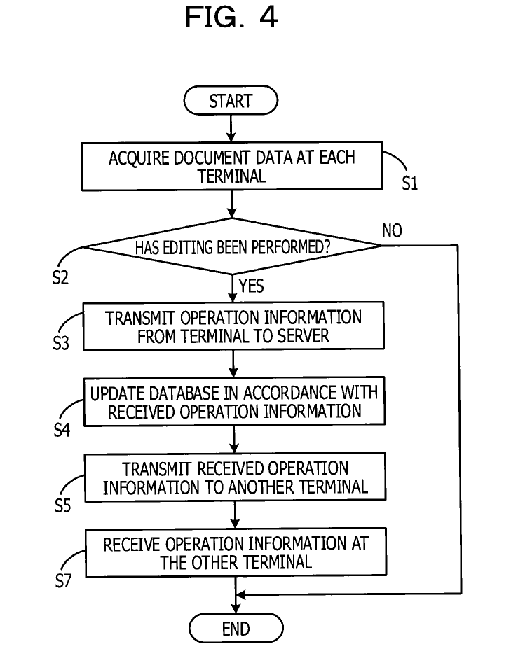

FIG. 4 is a flow chart, which illustrates an example of the synchronization process. The document synchronization unit 21 of each terminal 2 transmits an acquisition request of document data to the server 3. The document data acquisition unit 12 of the server 3 acquires certain document data from the database 6.

The server communication unit 14 of the server 3 transmits the document data to each terminal 2 via the network 5. The terminal communication unit 29 of each terminal 2 acquires the document data (step S1). Thus, synchronization of the document data is performed in each terminal 2.

Each terminal 2 determines whether or not editing has been performed on the document data (step S2). When editing has been performed on the document data in none of the terminals 2 (NO in step S2), it is indicated that the document data are synchronized. Then, the process ends.

In contrast, when editing has been performed on the document data at least one of the terminals 2 (YES in step S2), the process for synchronizing the document data is performed. In this case, the terminal 2 transmits the operation information that indicates the content of the editing to the server 3 (step S3).

The document data update unit 13 of the server 3 updates the document data in the database 6 in accordance with the received operation information (step S4). The server 3 transmits the received operation information to the other terminal 2 (step S5). The other terminal 2 reflects the received operation information in the document data (step S6).

As described above, even when the document data has been edited by any one of the terminals 2, the document data after the editing are synchronized between the terminals 2. The synchronization process in FIG. 4 is an example and the synchronization of the document data between the terminals 2 may employ a given method.

[Example of Operation that influences Operability]

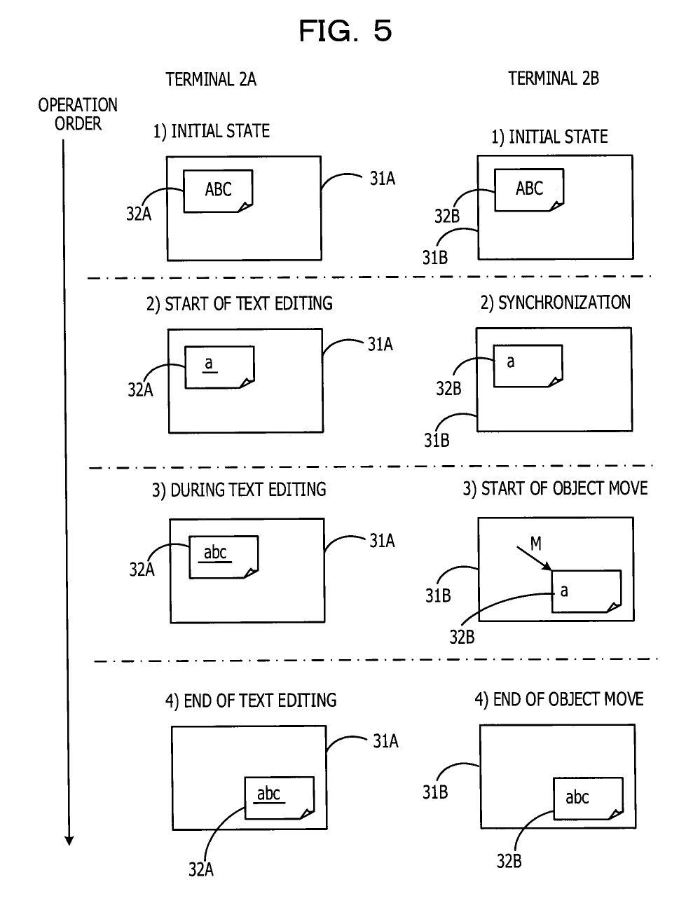

FIG. 5 illustrates an example of operation that influences operability. FIG. 5 illustrates examples of the screens on which the identical objects are being operated at the own terminal 2A and the other terminal 2B. In FIG. 5, “OPERATION ORDER” is based on the lapse of time, and the alternate long and short dashed lines indicate breaks of time.

In FIG. 5, document data 31A of the terminal 2A includes an object 32A. Document data 31B of the terminal 2B includes an object 32B. The object 32A and the object 32B are identical objects. In FIG. 5, the objects 32A and 32B are tags for example.

In “1) INITIAL STATE”, no operation is being performed on the document data 31A of the terminal 2A or the document data 31B of the terminal 2B. In the example of each “1) INITIAL STATE” in FIG. 5, each of the objects 32A and 32B includes text “ABC”.

In “2) START OF TEXT EDITING”, text editing of the object 32A is started at the terminal 2A, which may be referred to as the text input operation hereinafter. For example, in the example in FIG. 5, the user of the terminal 2A is inputting text “a” onto the object 32A using the input device 5. The underline of the text “a” indicates that the text is being edited.

When the text of the object 32A is edited to “a” at the terminal 2A, the document data 31A and the document data 31B are synchronized and the text of the object 32B of the terminal 2B is also changed to “a”.

In “3) DURING TEXT EDITING”, the text of the object 32A is edited to “abc” at the terminal 2A. At this time, the terminal 2B moves the object 32B in the direction indicated by arrow M. That is, the objects 32A and 32B that are identical are undergoing different operations at the same time at the terminal 2A and the terminal 2B.

The operation for the object 32A at the terminal 2A, which is referred to as the first operation, is the operation for the attribute of the text of the object 32A, and the operation for the object 32B at the terminal 2B, which is referred to as the second operation, is the operation for the attribute of the position of the object 32B.

That is, the first operation at the terminal 2A and the second operation at the terminal 2B are operations for the different attributes of the identical objects. Accordingly, the first operation and the second operation do not conflict. Thus, the first operation and the second operation may be performed at the same time.

It is assumed that in “4) END OF OBJECT MOVE”, the moving operation of the terminal 2B for the object 32B ends. When the document data of the terminal 2A and the document data of the terminal 2B are synchronized, the position of the object 32A of the terminal 2A also moves to the position corresponding to the object 32B of the terminal 2B.

The user who operates the terminal 2A is editing the text of the object 32A in “3) DURING TEXT EDITING”. The object 32A moves to the position corresponding to the object 32B although the terminal 2A performs no moving operation on the object 32A before “4) END OF TEXT EDITING”.

When the moving operation of the object 32B is reflected in the object 32A immediately, the object 32A moves while the user of the terminal 2A is performing the text input operation on the object 32A. The move is the operation that the user who operates the terminal 2A does not expect.

As a result, the user who operates the terminal 2A performs the text input on the object 32A to be moved and the operability in the input operation is decreased. Besides, an input error may be caused in the text input.

It is also assumable that the document synchronization unit 21 reflects the moving operation in the object 32A after the moving operation of the object 32B has ended. In this case, since the object 32A moves to another position suddenly, the user who operates the terminal 2A may lose sight of the object 32A on which the text input operation has been performed at the terminal 2A.

[First Specific Example of Operation Support Process]

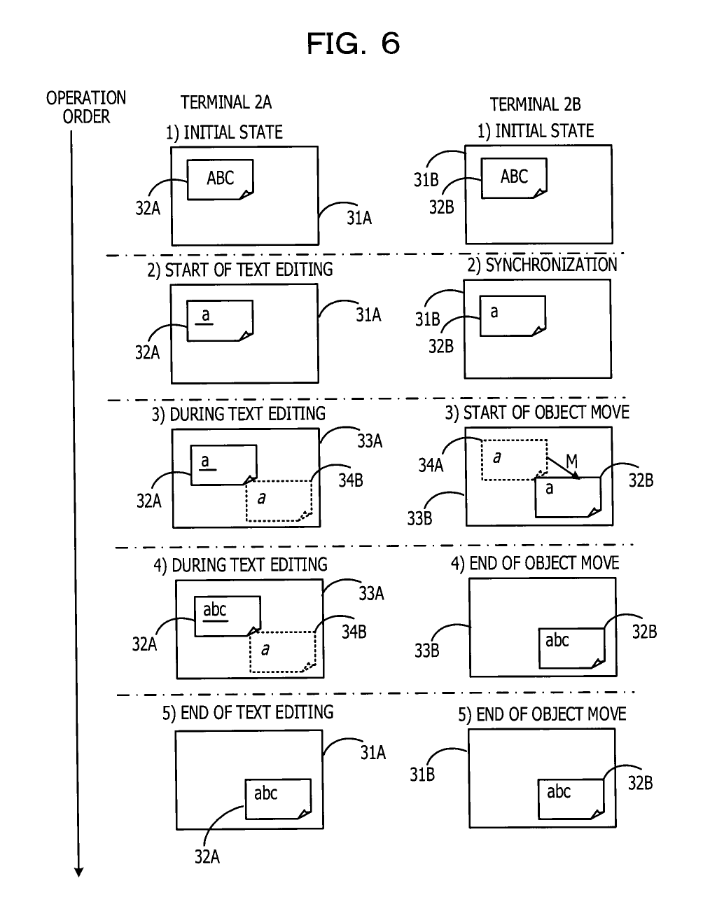

Referring now to the example in FIG. 6, a first specific example of an operation support process is described. The document synchronization unit 21 acquires document data from the database 6. In the example in FIG. 6, the document data includes an object. The object includes text “ABC”.

In the example in FIG. 6, the document data 31A of the terminal 2A includes the object 32A and the document data 31B of the terminal 2B includes the object 32B. The document data 31A and the document data 31B are identical and synchronized.

The user of the terminal 2A performs the text editing operation on the object 32A of the terminal 2A using the input device 5. The operation determination unit 22 of the terminal 2A determines that the text editing is being performed on the object 32A of the document data 31A.

The operation determination unit 22 of the terminal 2A identifies the object 32A being operated, or edited, from among the objects included in the document data 31A. In the example in FIG. 6, the text “ABC” in the object 32A of the terminal 2A is edited to the text “a”.

The document synchronization unit 21 of the terminal 2A transmits the operation information that indicates the text of the object 32A has been changed to “a” to the server 3. The document data update unit 13 updates the document data in the database 6. The server 3 transmits the operation information that indicates the text of the object 32A has been changed to “a” to the terminal 2B.

Since no operation is being performed at the terminal 2B, the document synchronization unit 21 of the terminal 2B changes the text of the object 32B to “a” in accordance with the received operation information. As a result, the document data 31A and the document data 31B are identical in the contents.

After that, the other user who operates the terminal 2B performs an operation of moving the object 32B in the direction indicated by arrow M. The operation determination unit 22 of the terminal 2B determines that moving operation is being performed. The operation determination unit 22 of the terminal 2B identifies the object 32B on which the operation has been performed.

The document synchronization unit 21 of the terminal 2B transmits the operation information that indicates that the moving operation has been performed on the object 32B to the server 3. Then, the database 6 is updated. The server 3 transmits the operation information that indicates that the moving operation has been performed on the object 32B to the terminal 2A.

At the terminal 2A, the text editing is being performed on the object 32A. The conflict determination unit 24 determines whether or not the first operation and the second operation conflict.

The first operation is the text input operation (the text editing) for the object 32A at the terminal 2A. The second operation is the moving operation for the object 32B at the terminal 2B.

In the embodiment, the conflict determination unit 24 of the terminals 2A and 2B determines whether or not the first operation and the second operation conflict in accordance with the contents stored in the table of the storage unit 26. In the above-described case, the conflict determination unit 24 determines that the first operation and the second operation do not conflict. Thus, the moving operation may be performed on the object 32B identical to the object 32A at the terminal 2B while the text editing operation is being performed on the object 32A at the terminal 2A.

Each influence determination unit 25 of the terminals 2A and 2B determines whether or not the first operation and the second operation influence the operability by referring to the table stored in the storage unit 26. In the example in FIG. 6, the influence determination unit 25 determines that the operability is influenced.

When the influence determination unit 25 determines that the operability is influenced, the provisional integration unit 27 of the terminal 2A applies the operation indicated by the second operation information of the terminal 2B to the replica data of the document data 31A and sets the resultant data as the provisional document data. Here, the provisional integration unit 27 of the terminal 2A applies the operation indicated by the second operation information, which indicates the moving operation of the object 32B, to the replica data and sets the resultant data to be provisional document data 33A.

The provisional integration unit 27 may replicate all of the document data 31A or may replicate only the object related to the second operation information, which is included in the objects in the document data 31A.

The replica of the object 32A included in the provisional document data 33A, to which the operation indicated by the second operation information is applied, is referred to as an applied object 34B. The applied object 34B is displayed in a manner different from the display of the object 32A, which is the original object of the replication. In the example in FIG. 6, the applied object 34B is indicated by dashed lines and the text of the applied object 34B is indicated in italics. The object 32A is the object included in the document data 31A and the applied object 34B is the object included in the provisional document data 33A.

The provisional document data display unit 28 of the terminal 2A causes the provisional document data 33A to be displayed on the screen of the display device 4. Since the second operation by the other terminal 2B is applied to the applied object 34B, the user who operates the terminal 2A may visually recognize the content of the second operation of the other terminal 2B by visually discerning the applied object 34B.

The moving operation of the object 32B at the terminal 2B is reflected in the applied object 34B included in the provisional document data 33A for every move. Thus, the user who operates the terminal 2A may check the move of the applied object 34B on the screen of the display device 4 one by one.

Accordingly, the user who operates the terminal 2A may recognize that moving operation has been performed at the other terminal 2B on the object 32B identical to the object 32A that the user of the terminal 2A is operating, and thus the operability is enhanced.

Since the object 32A that the user of the terminal 2A is operating and the applied object 34B are displayed in different manners, the user who operates the terminal 2A may easily identify the object 32A that the user of the terminal 2A is operating.

The display device 4 of the terminal 2A displays the applied object 34B when the influence determination unit 25 determines that the operability is influenced. When the operability is not influenced, the applied object 34B is not displayed.

If the applied object 34B is displayed on the screen of the display device 4 when there is no influence on the operability, the viewability of the user who operates the terminal 2A is affected. Thus, when there is no influence on the operability, decrease in the user's viewability may be avoided by the provisional document data display unit 28 causing the applied object 34B to be undisplayed.

In the example in FIG. 6, “4) END OF OBJECT MOVE” indicates that the moving operation as the second operation of the object 32B ends at the terminal 2B. At the time, the text of the object 32A is being edited to “abc” at the terminal 2A. The result of the text editing is reflected in the object 32B of the terminal 2B. Thus, the text of the object 32B is changed to “abc”.

In “4) DURING TEXT EDITING” in the example in FIG. 6, the object 32A is being operated and accordingly, the applied object 34B included in the provisional document data 33A remains displayed as in “3) DURING TEXT EDITING” in the example in FIG. 6.

The provisional integration unit 27 of the terminal 2A abandons the provisional document data 33A when the operation determination unit 22 determines that no operation is being performed. After that, the provisional document data display unit 28 causes the applied object 34B included in the provisional document data 33A to be undisplayed. As a result, the applied object 34B is not displayed on the display device 4.

Thus, as illustrated in “5) END OF TEXT EDITING” in the example in FIG. 6, the text of the object 32A is edited to “abc”. The moving operation of the object 32B, which has been performed at the terminal 2B, is applied to the object 32A included in the document data 31A and the position of the object 32A is changed. As described above, the document data 31A of the terminal 2A and the document data 31B of the terminal 2B become identical.

[Second Specific Example of Operation Support Process]

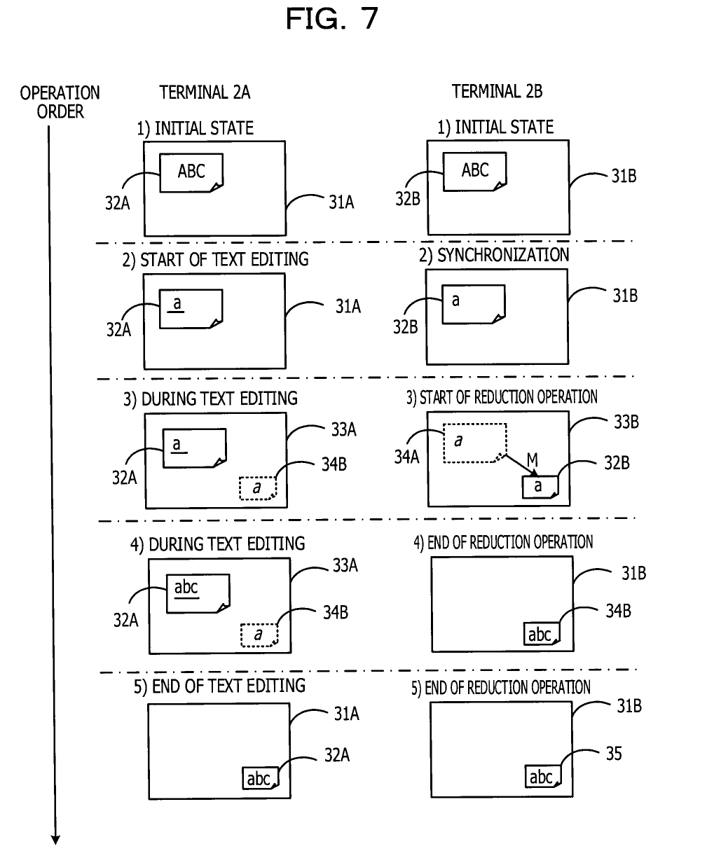

Referring now to the example in FIG. 7, a second specific example of the operation support process is described. In FIG. 7, “1) INITIAL STATE” and “2) START OF TEXT EDITING” of the terminal 2A, and “1) INITIAL STATE” and “2) SYNCHRONIZATION” of the terminal 2B are the same as the example in FIG. 6.

In “3) DURING TEXT EDITING” in FIG. 7, the operation determination unit 22 of the terminal 2A determines that one of the objects included in the document data 31A is being operated. The operation determination unit 22 of the terminal 2A identifies the object 32A as the object being operated.

The operation information acquisition unit 23 of the terminal 2A acquires the second operation information of the terminal 2B. At the terminal 2A, the text editing operation is being performed on the object 32A.

In the example of “3) START OF REDUCTION OPERATION” in FIG. 7, reduction operation is being performed on the document data 31B at the terminal 2B. When the document data 31B occupies the entire screen, the reduction operation is performed for the screen of the display device 4. Although the example in FIG. 7 demonstrates the reduction operation, the operation performed at the terminal 2B may be enlargement operation or moving operation. The enlargement operation, the reduction operation, and the moving operation may also be referred to as panning and zooming.

Since the first operation at the terminal 2A is the text editing operation of the object 32A and the second operation at the terminal 2B is the reduction operation of the document data 31B, each conflict determination unit 24 of the terminals 2A and 2B determines that the two operations do not conflict by referring to the table of the storage unit 26. Each influence determination unit 25 of the terminals 2A and 2B determines that the operations influence the operability by referring to the table of the storage unit 26.

Accordingly, the provisional integration unit 27 of the terminal 2A applies the reduction operation, which has been performed at the terminal 2B, to the provisional document data 33A created by replicating the document data 31A. The provisional integration unit 27 of the terminal 2B applies the text editing of the object 32A, which has been performed at the terminal 2A, to provisional document data 33B created by replicating the document data 31B. The object included in the provisional document data 33B, to which the text editing is applied, is referred to as an applied object 34A.

As illustrated in the example in FIG. 7, when the reduction operation is performed at the terminal 2B, the provisional document data display unit 28 causes the display device 4 of the terminal 2A to display both the object 32A that is being edited and the provisional document data 33A to which the reduction operation is applied. Thus, the user who operates the terminal 2A may recognize that the reduction operation has been performed at the terminal 2B.

In this example, the text input operation for the object 32A and the reduction operation for the document data 31B are performed. That is, even when the object included in the document data and the identical document data are operated at the same time, the terminal 2A may recognize the operation of the terminal 2B, and the operability is enhanced accordingly.

[Third Specific Example of Operation Support Process]

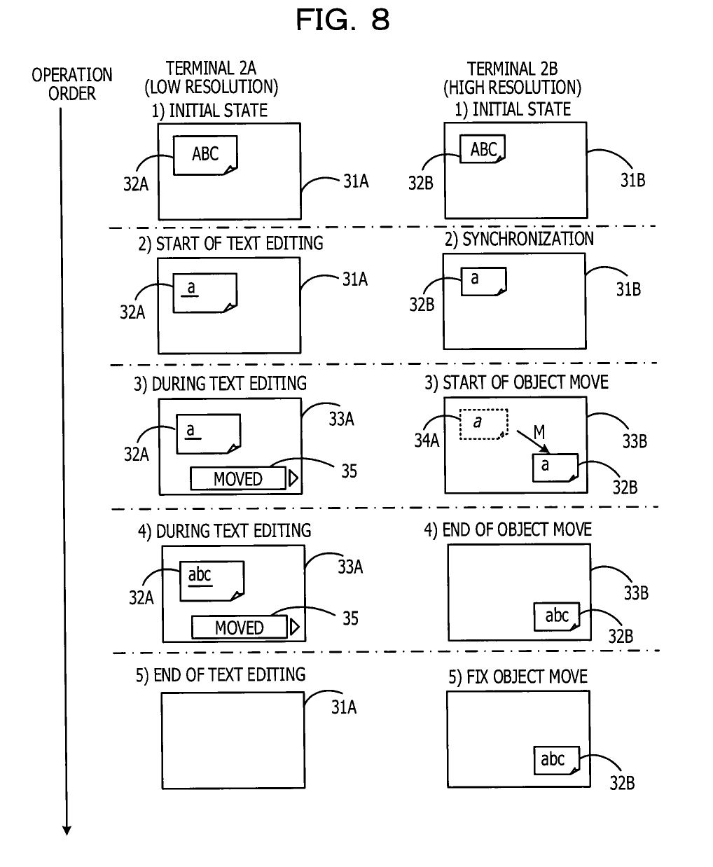

Referring now to the example in FIG. 8, a third specific example of the operation support process is described. In this example, the display device 4 of the terminal 2A has low resolution and the display device 4 of the terminal 2B has high resolution.

The document data 31A and the document data 31B are displayed over the entire screens. In the example in FIG. 8, regardless of the resolution, the screen of the display device 4A of the terminal 2A may undergo the enlargement operation or the screen of the display device 4B of the terminal 2B may undergo the reduction operation.

In the present example, the user who operates the terminal 2A performs the operation of editing the text of the object 32A and the user who operates the terminal 2B performs the operation of moving the object 32B. The procedures performed by the document synchronization unit 21, the operation determination unit 22, the operation information acquisition unit 23, the conflict determination unit 24, the influence determination unit 25, and the provisional integration unit 27 according to this example are similar to those in the first specific example of the operation support process. Thus, the provisional integration unit 27 of the terminal 2A creates the provisional document data 33A to which the operation indicated by the second operation information is applied. The provisional document data 33A includes the applied object 34B, which corresponds to the object 32A and has undergone the application of the operation indicated by the second operation information.

It is assumed in “3) START OF OBJECT MOVE” in FIG. 8 that the moving operation of the object 32B is largely performed at the terminal 2B. Since the display device 4 of the terminal 2B has high resolution, the object 32B that has been moved remains displayed on the screen of the display device 4.

In contrast, the display device 4 of the terminal 2A has low resolution. In this case, when the provisional integration unit 27 of the terminal 2A applies the operation indicated by the second operation information on the move of the object 32B to the provisional document data 33A, the object may be no more displayed on the screen due to the low resolution of the display device 4 of the terminal 2A.

When the second operation information is not displayed on the display device 4 of the terminal 2A, the user who operates the terminal 2A may not recognize the influence that the second operation of the terminal 2B exerts on the object 32A. Thus, the user's operability of the terminal 2A is decreased.

In this case, the provisional document data display unit 28 causes character information 35, such as “MOVED”, to be displayed, which indicates that the applied object 34B corresponding to the object 32A has moved out of the region of the screen. The character information 35 is calculated in accordance with the second operation information and the applied object 34B.

The user who operates the terminal 2A visually recognizes the character information 35 on the screen of the display device 4 in editing the text of the object 32A.

As a result, the character information 35 may enable the user who operates the terminal 2A to recognize that the object 32A is no more displayed on the screen of the display device 4 after the end of the text editing for the object 32A.

[Example of Abandonment Operation]

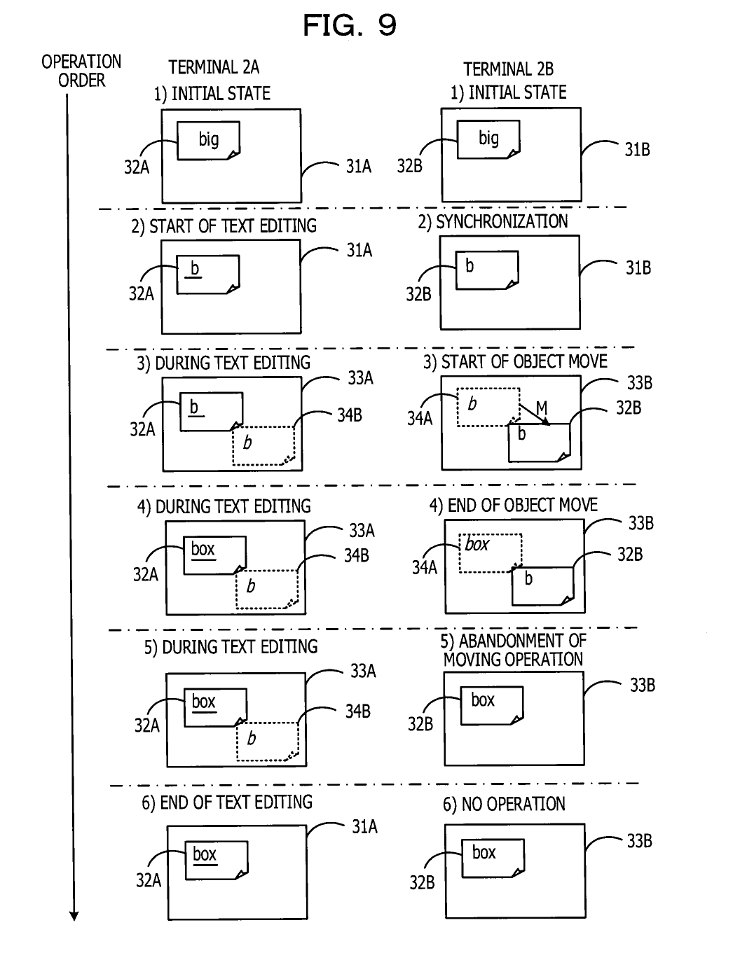

Referring now to FIG. 9, an example in which the operation performed at the terminal 2 is abandoned is described. FIG. 9 illustrates the example in which the moving operation is abandoned when the moving operation of an object is performed.

For example, the user who operates the terminal 2B is performing the task of not moving an object including an English word but moving an object including an alphabet that does not make up an English word. In the example in FIG. 9, when in “5) DURING TEXT EDITING”, an English word is input to the text of the object 32A at the terminal 2A, the user who operates the terminal 2B rethinks the moving operation of the object 32B corresponding to the object 32A and abandons the moving operation of the object 32B of the terminal 2B.

As illustrated in the example of “2) SYNCHRONIZATION” in FIG. 9, at the time of “2) SYNCHRONIZATION”, the object 32B of the terminal 2B includes an alphabet “b”, which does not make up an English word. The user who operates the terminal 2B attempts to move the object 32B. At the same time, the user who operates the terminal 2A edits the text of the object 32A to “box”. Before “4) DURING TEXT EDITING” in FIG. 9, the text of the object 32A has been edited to “box”. Since “box” is an English word, in “5) ABANDONMENT OF MOVING OPERATION” in FIG. 9, the user of the terminal 2B follows the task and abandons the moving operation of the object 32B, which has been performed before “4) END OF OBJECT MOVE” in FIG. 9.

The procedures performed by the document synchronization unit 21, the operation determination unit 22, the operation information acquisition unit 23, the conflict determination unit 24, the influence determination unit 25, the provisional integration unit 27, and the provisional document data display unit 28 according to the present example are similar to those in the first specific example of the operation support process. Thus, the provisional integration unit 27 of the terminal 2B creates the provisional document data 33B indicated by the first operation information. The provisional document data 33B includes the applied object 34A, which corresponds to the object 32B and has undergone the application of the operation indicated by the first operation information.

In “4) END OF OBJECT MOVE” in the example in FIG. 9, the provisional document data display unit 28 causes the applied object 34A to be displayed on the display device 4 of the terminal 2B. The applied object 34A indicates that the editing is performed on the object 32A at the terminal 2A for the English word “box”.

Accordingly, the user who operates the terminal 2B and is performing the task may recognize that the moving operation of the object 32B is no more desired. As a result, the user of the terminal 2B may abandon the moving operation and thus, the operability may be enhanced. The example of the abandonment operation is not limited to the above-described example.

[Example of Flow Chart of Operation Support Process]

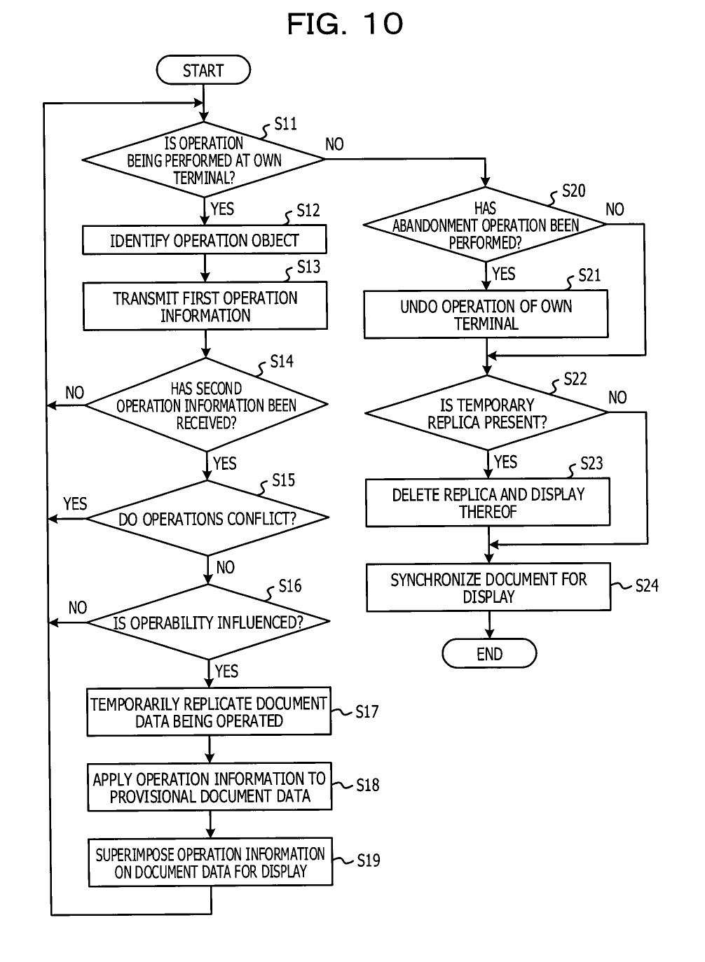

An example of a flow chart of the operation support process is now described with reference to FIG. 10. The operation determination unit 22 of the terminal 2A determines whether or not operation is currently being performed at the own terminal 2A (step S11).

When the operation determination unit 22 determines that operation is currently being performed at the own terminal 2A (YES in step S11), the operation determination unit 22 identifies the object on which the operation is being performed from among document data (step S12).

The terminal communication unit 29 of the terminal 2A transmits the information on the operation at the terminal 2A to the server 3 as the first operation information (step S13). The server 3 updates the database 6 in accordance with the received first operation information. The first operation information may indicate not only the operation for an object included in the document data but may also indicate the operation for the document data.

The server 3 transmits the received first operation information to the other terminal 2B. Similarly, when operation is being performed, the other terminal 2B transmits the second operation information to the server 3. The server 3 updates the database 6 in accordance with the received second operation information. Further, the server 3 transmits the received second operation information to the terminal 2A.

The operation information acquisition unit 23 of the terminal 2A determines whether or not the terminal communication unit 29 has received the second operation information from the server 3 (step S14). The second operation information is the information on the operation of the terminal 2B. The second operation information may indicate not only the operation for an object included in the document data but may also indicate the operation for the document data.

When the operation information acquisition unit 23 determines that the second operation information has not been received (NO in step S14), the process returns to step 11. For example, when no operation is being performed at the terminal 2B, the terminal 2A does not receive the second operation information.

When operation is being performed at the terminal 2B, the terminal 2A receives the second operation information from the server 3. Thus, the operation information acquisition unit 23 of the terminal 2A determines that the second operation information has been received (YES in step S14).

After that, the conflict determination unit 24 determines whether or not the first operation and the second operation conflict by referring to the table in the storage unit 26 (step S15). When the first operation and the second operation are in a conflicting relation, the process returns to step 11.

When the first operation and the second operation are not in the conflicting relation, the influence determination unit 25 determines whether or not the first operation and the second operation influence the operability, depending on the first operation and the second operation (step S16). The influence determination unit 25 determines whether or not the operability is influenced by referring to the table in the storage unit 26.

When the influence determination unit 25 determines that the operability is not influenced (NO in step S16), no particular process is performed. When the determination result is NO in step S16, the process returns to step 11.

When the influence determination unit 25 determines that the operability is influenced (YES in step S16), the provisional integration unit 27 of the terminal 2A temporarily replicates the document data (step S17). The temporarily replicated document data is the provisional document data 33A.

The provisional integration unit 27 applies the operation indicated by the received second operation information to the provisional document data 33A. The second operation information is the information on the operation of the terminal 2B. For example, when the second operation information indicates the editing operation for an object, the provisional integration unit 27 applies the editing operation indicated by the operation information to the object indicated by the operation information and included in the provisional document data of the terminal 2A (step S18).

After that, the provisional document data display unit 28 causes the provisional document data 33A to which the second operation information is applied to undergo superimposition display on the display device 4 (step S19).

As a result, the user who operates the terminal 2A may recognize the second operation information due to the provisional document data 33A displayed on the display device 4. When step S19 ends, the process returns to step 11.

When the operation determination unit 22 determines that no operation is being performed at the own terminal 2A (NO in step S11), the operation determination unit 22 determines whether or not the abandonment operation has been performed (step S20). When the abandonment operation has been performed (YES in step S20), the operation of the own terminal 2A is undone (step S21). When no abandonment operation has been performed (NO in step S20), step S21 is skipped.

The provisional integration unit 27 of the terminal 2A determines whether or not the temporary replica of the document data, that is, the provisional document data is present (step S22). When the provisional document data is present (YES in step S22), the provisional integration unit 27 deletes the provisional document data and the provisional document data display unit 28 deletes the display of the provisional document data (step S23). When the provisional document data is absent (NO in step S22), step S23 is skipped.

After that, the document synchronization unit 21 synchronizes the document data (step S24). The document data to which the operations that the first operation information and the second operation information indicate are applied are displayed at the terminal 2A.

Thus, even when some operation is performed at the other terminal 2B where the document data is being synchronized while the user of the terminal 2A is operating the terminal 2A, the provisional document data to which the operation indicated by the second operation information is applied is sequentially displayed at the terminal 2A. Accordingly, the user who operates the terminal 2A may sequentially and visually recognize the operation performed at the terminal 2B, and the operability may be enhanced.

[Example of Storage Unit]

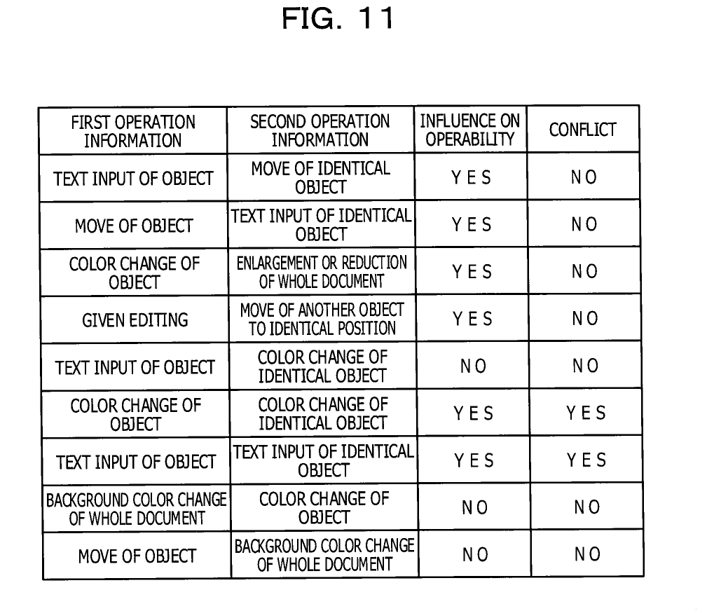

Referring now to FIG. 11, an example of the table that the storage unit 26 stores is described. The table that the storage unit 26 stores indicates whether or not the operability is influenced and whether or not a conflict is present when, for each individual combination of the first operation information and the second operation information, the operation indicated by the second operation information is applied to the original document data instead of applying the operation indicated by the second operation information to the provisional document data created in the provisional integration unit 27. It is assumed below that the object 32A and the object 32B are the objects illustrated in the example in FIG. 5. However, the objects in the description below are not limited to the objects 32A and 32B in the example in FIG. 5.

When the first operation information indicates the text input of an object and the second operation information indicates the move of the identical object, the operability is influenced. When a user performs the text input operation on the object 32A of the terminal 2A, another user performs the moving operation on the object 32B corresponding to the object 32A using the terminal 2B.

In this case, the object 32A is moved as the moving operation for the object 32B is applied to the object 32A sequentially. The move is the operation that the user who operates the terminal 2A does not expect. Thus, the operability of the user who operates the terminal 2A is influenced. Thus, “INFLUENCE ON OPERABILITY” in the table in FIG. 11 indicates “YES”.

The first operation and the second operation are operations for the identical objects. Since the operations are directed at the different and independent attributes of the identical objects, the first operation and the second operation do not conflict. Thus, “CONFLICT” in the table in FIG. 11 indicates “NO”. Even when the operations are performed for different attributes of the objects, if there is a dependent relation, the first operation and the second operation conflict. The results are similar when the first operation and the second operation are reversed.

Even when the first operation information indicates change in the color of the object and the second operation information indicates enlargement or reduction of the entire document data, “INFLUENCE ON OPERABILITY” in the table in FIG. 11 indicates “YES”. The enlargement or reduction of the entire document data is an unexpected operation for the user who is performing the color changing operation on the object. Thus, the operability is influenced. Since the target objects of the operations indicated by the first operation information and the second operation information are different, “CONFLICT” in the table in FIG. 11 indicates “NO”.

When the first operation information indicates given editing of an object and the second operation information indicates move of another object to a position identical to that of the object, “INFLUENCE ON OPERABILITY” in the table in FIG. 11 indicates “YES”. For example, it is assumed that while the color changing operation is being performed on the object 32A at the terminal 2A, another object is moved by the terminal 2B to the position of the object 32A.

In this case, the objects overlap partially or entirely, each user reduces his or her viewability and operability. Accordingly, “INFLUENCE ON OPERABILITY” in the table in FIG. 11 indicates “YES”. Since the target objects of the operations indicated by the first operation information and the second operation information are different, “CONFLICT” in the table in FIG. 11 indicates “NO”

When the first operation information indicates the text input of an object and the second operation information indicates change in the color of the identical object, “INFLUENCE ON OPERABILITY” in the table in FIG. 11 indicates “NO”. Even when the color of the identical object is changed while the text input of the object is being performed, the operability is not influenced or the influence is minor influence. When the influence on the operability is minor influence, in the embodiment, it is regarded as no influence on the operability. Since the target attributes of the operations indicated by the first operation information and the second operation information are different and independent, “CONFLICT” in the table in FIG. 11 indicates “NO”.

When the first operation information indicates change in the color of an object and the second operation information indicates change in the color of the identical object, the operations are performed for the identical attributes of the identical objects and thus, “CONFLICT” in the table in FIG. 11 indicates “YES”. Likewise, “INFLUENCE ON OPERABILITY” indicates “YES”. When the first operation information indicates text input of an object and the second operation information indicates text input of the identical object, the results are similar.

When the first operation information indicates change in the background color of entire document data and the second operation information indicates change in the color of an object, the operability is not influenced or the influence is minor influence and thus, “INFLUENCE ON OPERABILITY” in the table in FIG. 11 indicates “NO”. Since the target objects of the operations indicated by the first operation information and the second operation information are different, “CONFLICT” in the table in FIG. 11 indicates “NO”. When the first operation information indicates move of an object and the second operation information indicates change in the background color of an entire document, the results are similar.

The combinations of the first operation information and the second operation information are not limited to the examples in FIG. 11. For example, the first operation information or the second operation information may be information on the operation related to the size or shape of an input area of an object, a style of a frame that surrounds the input area, or the like. Further, the first operation information or the second operation information may be information that indicates the operation of editing a decorative element of the text, such as a font, a size, a color, a thickness, or an underline.

[Example indicating Temporal Transition of Operation Support Process]

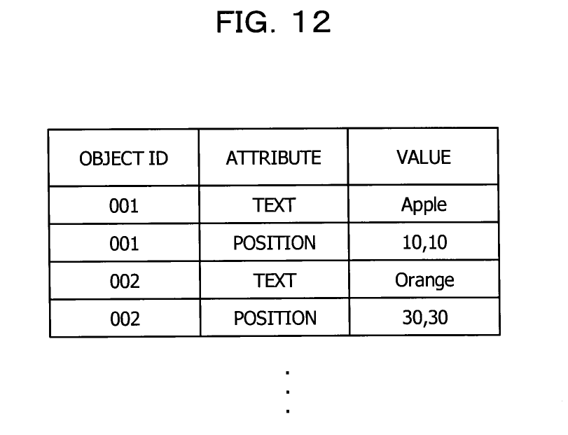

Referring now to FIGS. 12 to 14, an example that indicates temporal transition of the operation support process is described. FIG. 12 is an example of a table, which indicates relations among the object IDs, attributes, and values of the objects included in document data. For example, the document data that includes a plurality of objects may be expressed using the table in the example in FIG. 12. The table in the example in FIG. 12 is stored in the database 6.

The document data acquisition unit 12 may acquire the table stored in the database 6. The document data update unit 13 may update or delete the table stored in the database 6.

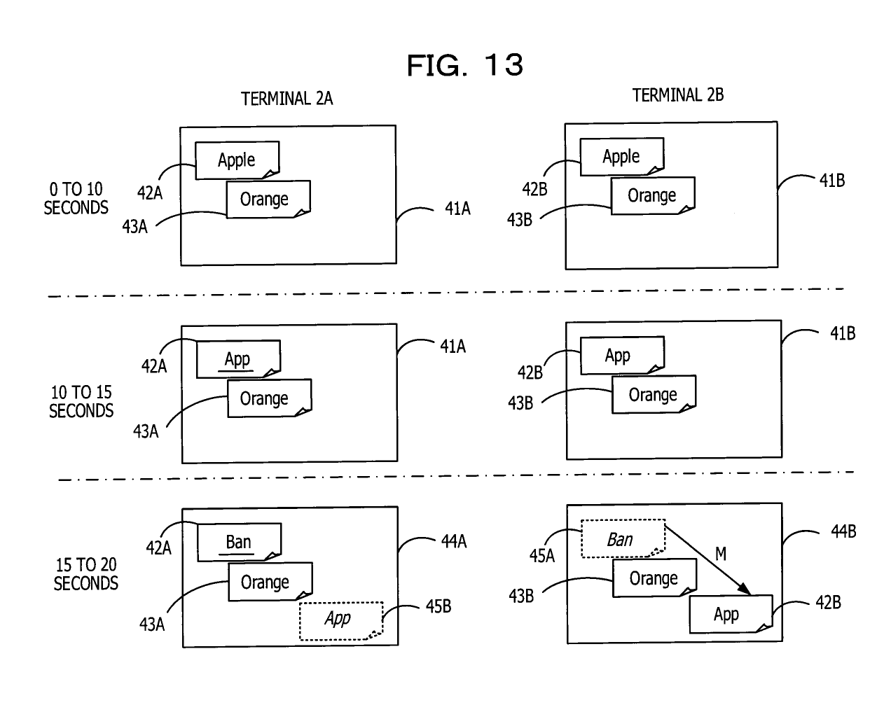

The example in FIG. 13 indicates document data 41A of the terminal 2A and document data 41B of the terminal 2B. The terminal 2A and the terminal 2B are distinguished at the server 3. Each document synchronization unit 21 of the terminals 2A and 2B requests the server 3 to acquire document data.

The server 3 transmits the document data presented in the table in FIG. 12 to the terminal 2A and the terminal 2B. In the initial state, the document data 41A of the terminal 2A and the document data 41B of the terminal 2B are identical in contents. In this state, as illustrated in “0 TO 10 SECONDS” in FIG. 13, objects 42A and 42B with the object ID corresponding to “001”, and objects 43A and 43B with the object ID corresponding to “002” are equally displayed on the display devices 4 of the terminals 2A and 2B.

In “0 TO 10 SECONDS” illustrated in FIG. 13, the user who operates the terminal 2A performs no operation on the document data 41A and similarly, the user who operates the terminal 2B performs no operation on the document data 41B. Accordingly, the objects 42A and 42B remain unchanged. The objects 43A and 43B also remain unchanged.

As described above, the user who operates the terminal 2A may operate the document data 41A using the input device 5. The user who operates the terminal 2B may operate the document data 41B using the input device 5.

The information on the operation of the terminal 2A is transmitted to the server 3 one by one as the first operation information when operation is performed at the terminal 2A. The document data update unit 13 of the server 3 updates the above-described table in the database 6 in accordance with the first operation information.

The information on the operation of the terminal 2B is transmitted to the server 3 one by one as the second operation information when operation is performed at the terminal 2B. The document data update unit 13 of the server 3 updates the above-described table in the database 6 in accordance with the second operation information. The server communication unit 14 of the server 3 transmits the first operation information or the second operation information to the terminals 2, which include the terminals 2A and 2B, when change occurs in the database 6.

Each operation determination units 22 of the terminals 2A and 2B determines whether or not operation is currently being performed. For example, when dragging operation is being performed on the object or when time elapsed after the last dragging operation has been performed is within certain time, such as one second, the operation determination unit 22 determines that operation is being performed.

For example, when text input is being performed on the object or time elapsed after the last text input has been performed is within certain time, such as one second, the operation determination unit 22 determines that operation is being performed.

It is assumed that the user who operates the terminal 2A starts the text input operation on the object 42A at the timing of “10 seconds” and the text input operation ends at the timing of “25 seconds”. Accordingly, the operation determination unit 22 of the terminal 2A determines that the operation is being performed from “10 seconds” to “26 seconds”.

The terminal communication unit 29 of the terminal 2A transmits the first operation information to the server 3 every time the text of the object 42A is changed. In the case of “10 TO 15 SECONDS” in FIG. 13, the text of the object 42A of the terminal 2A is changed to “App”. In this case, the first operation information is information on the text input operation for the object 42A, which includes the object ID “001” corresponding to the object 42A and the content of the text input, “App”.

The document data update unit 13 of the server 3 updates the database 6 in accordance with the received first operation information. The server 3 transmits the first operation information to the terminal 2B. Since the user who operates the terminal 2B is performing no operation, the document synchronization unit 21 reflects the operation indicated by the first operation information in the document data 41B.

The document synchronization unit 21 of the terminal 2B changes the text of the object 42B corresponding to the object ID “001”, which is indicated by the operation information, to “App” in accordance with the first operation information transmitted from the server 3.

The operations at the terminals 2A and 2B from the timing of “10 seconds” to the timing of “15 seconds” are described above. Below described are the operations at the terminals 2A and 2B from the timing of “15 seconds” to the timing of “20 seconds”.

As described above, since the user who operates the terminal 2A keeps performing the text input operation until the timing of “25 seconds”, the operation determination unit 22 determines that the text input operation continues to be performed on the object 42A of the terminal 2A in “15 TO 20 SECONDS”. In the example of “15 TO 20 SECONDS” in FIG. 13, the text of the object 42A is changed to “Ban”.

At the terminal 2B, moving operation is being performed on the object 42B. The operation information acquisition unit 23 of the terminal 2A acquires the second operation information on the moving operation for the object 42B. The influence determination unit 25 determines the influence on the operability regarding a combination of the first operation information on the text input operation being performed on the object 42A at the terminal 2A and the second operation information on the moving operation for the object 42B.

The first operation information indicates the input operation for the text of the object with the object ID “001” and the second operation information indicates the moving operation of the object with the identical object ID “001”. Thus, the influence determination unit 25 determines that “INFLUENCE ON OPERABILITY” indicates “YES” by referring to the table in the storage unit 26. That is, the influence determination unit 25 determines that the operability is influenced. Since the target attributes of the operations indicated by the first operation information and the second operation information are different, which are the text and the position, it is determined that “CONFLICT” indicates “NO”.

In accordance with the determination results of the influence determination unit 25, the provisional integration unit 27 of the terminal 2A replicates the document data 41A and sets the replica of the document data as provisional document data 44A. Since the second operation information received at the terminal 2A is the operation information on the object with the object ID “001”, the provisional integration unit 27 may replicate only the data on the object ID “001” included in the document data 41A instead of replicating the whole document data 41A.

When the terminal 2A already stores the provisional document data 44A and when the provisional document data 44A includes data regarding the object with the object ID “001”, to which the received second operation information refers to, the provisional integration unit 27 may avoid the replication of the document data 41A and may use the stored provisional document data 44A.

After that, the provisional integration unit 27 applies the operation indicated by the received second operation information to the provisional document data 44A. As described above, the second operation information indicates the moving operation of the object with the object ID “001”. Thus, in the provisional document data 44A, the attribute of the position regarding the object with the object ID “001” is updated. According to the updated provisional document data 44A, the provisional document data display unit 28 superimposes an object 45B corresponding to the object ID “001” on the objects 42A and 43A and causes the superimposed object 45B to be displayed. Hereinafter, the object caused to be displayed by the provisional document data display unit 28 in accordance with the provisional document data is referred to as the applied object. Specifically, the object 45B is referred to as the applied object 45B.

Accordingly, as illustrated in the example of “15 TO 20 SECONDS” in FIG. 13, the applied object 45B is displayed at the terminal 2A at the position identical to the position of the object 42B corresponding to the object ID “001” of the document data 41B at the terminal 2B. The text of the applied object 45B becomes “App”, which is displayed at the time when the provisional integration unit 27 replicates the provisional document data 44A.

The provisional document data display unit 28 causes the applied object 45B and the other object to be displayed in different manners in accordance with the provisional document data 44A. As a result, the user who operates the terminal 2A may recognize that the object 42B corresponding to the object ID “001” has undergone the moving operation at the terminal 2B. The user who operates the terminal 2A may visually distinguish that the applied object 45B is displayed in accordance with the provisional document data 41A.

In “15 TO 20 SECONDS”, the operation determination unit 22 of the terminal 2B determines that the moving operation is being performed on the object 42B. At the time, the terminal 2A is performing the text input operation on the object 42A.

The operation information acquisition unit 23 of the terminal 2B acquires the first operation information of the terminal 2A. In accordance with the first operation information and the second operation information, the influence determination unit 25 of the terminal 2B determines whether or not the operability is influenced. Since the first operation information is the information on the text input operation for the object 42A corresponding to the object ID “001” in the document data 41A and the second operation information is the information on the moving operation for the object 42B corresponding to the identical object ID “001” in the document data 41B, the influence determination unit 25 determines that the operability is influenced.

Thus, the provisional integration unit 27 of the terminal 2B replicates the data with the object ID “001”, which is included in the document data 41B, and creates provisional document data 44B. After that, the provisional integration unit 27 of the terminal 2B applies the operation indicated by the received first operation information to the provisional document data 44B. Since the operation information indicates the text input operation for the object with the object ID “001” as described above, among the data in the provisional document data 44B, the attribute of the text related to the object with the object ID “001” is updated. When the storage unit 26 of the terminal 2B stores the provisional document data 44B, the provisional document data 44B is used.

The provisional document data display unit 28 of the terminal 2B performs superimposition display on an applied object 45A based on the provisional document data 44B. The text of the applied object 45A becomes identical to the text edited at the terminal 2A. Accordingly, the text of the applied object 45A turns “Ban” as illustrated in “15 TO 20 SECONDS” in FIG. 13. Since, among the data in the provisional document data 44B, the attribute of the position related to the object with the object ID “001” is not updated, the position of the applied object 45A remains the same as the position at the time when the provisional document data 44B is created in the provisional integration unit 27, and becomes the same as the position of the object 42B at the time, which is included in the document data 41B and corresponds to the object ID “001”.

As a result, the user who operates the terminal 2B may visually recognize that the text input operation has been performed on the object 42A corresponding to the object ID “001” at the terminal 2A. Since the applied object 45A is displayed in a different manner, the user who operates the terminal 2B may visually distinguish that the applied object 45A is displayed in accordance with the provisional document data 44B.

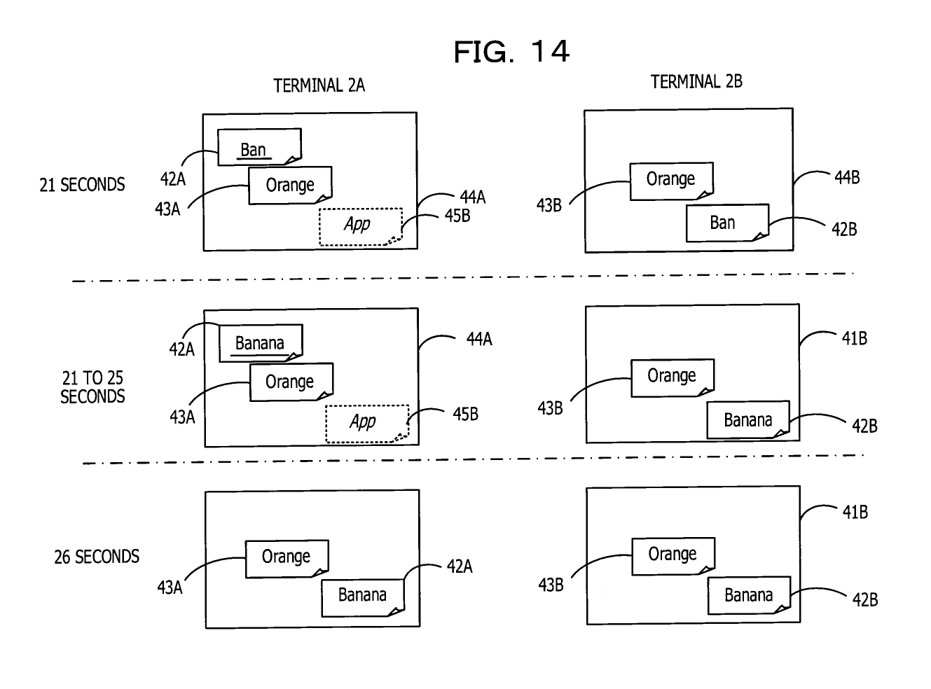

Referring now to “21 SECONDS” in FIG. 14, the process performed at the terminal 2B at the timing of “21 SECONDS” is described.

At the terminal 2B, the moving operation of the object 42B is performed from “15 TO 20 SECONDS”. Since at the timing of “21 SECONDS”, “one second” has elapsed after the user who operates the terminal 2B had ended the moving operation at “20 seconds”, the operation determination unit 22 of the terminal 2B determines that the moving operation of the object 42B has ended.

Since it is determined in the operation determination unit 22 of the terminal 2B that no operation is being performed, the provisional integration unit 27 of the terminal 2B abandons the provisional document data 44B. Thus, the provisional document data display unit 28 causes the provisional document data 44B to be undisplayed on the screen of the display device 4. The document synchronization unit 21 of the terminal 2B acquires the document data including the information on the object ID “001”, which corresponds to the applied object 45A, from the server 3. The document synchronization unit 21 of the terminal 2B changes the object 42B corresponding to the object ID “001” in accordance with the acquired document data 41B. Thus, as illustrated in the example of “21 SECONDS” in FIG. 14, the text of the object 42B is changed to “Ban”. Accordingly, as illustrated in “21 SECONDS” in FIG. 14, the document data 41B to which both the first operation and the second operation are applied is displayed on the screen of the display device 4 of the terminal 2B.

The processes of the terminals 2A and 2B at the timings from “21 TO 25 SECONDS” are described below. At the terminal 2A, the text input operation is being performed on the object 42A. In the example of “21 TO 25 SECONDS” of the terminal 2A in FIG. 14, the text of the object 42A is changed to “Banana”.

The document synchronization unit 21 of the terminal 2B synchronizes the document data 41B with the server 3 every time the text input operation is performed on the object 42A at the terminal 2A. Accordingly, the content of the text input operation performed for the object 42A at the terminal 2A is reflected one by one in the object 42B of the terminal 2B. In the example of “21 TO 25 SECONDS” of the terminal 2B in FIG. 14, the text of the object 42B is changed to “Banana”, which is the same as the text of the object 42A.

The process of the terminal 2A at the timing of “26 SECONDS” is now described. The document data 44B of the terminal 2B remains unchanged.

At the terminal 2A, the text input operation is kept for the object 42A until “25 seconds”. Since at the timing of “26 SECONDS”, “one second” has elapsed after the user who operates the terminal 2A had ended the text input operation at “25 seconds”, the operation determination unit 22 of the terminal 2A determines that the text input operation is not being performed. The provisional integration unit 27 of the terminal 2A abandons the provisional document data 44A.

Thus, the provisional document data display unit 28 of the terminal 2A causes the provisional document data 44A to be undisplayed on the screen of the display device 4. The document synchronization unit 21 of the terminal 2A acquires the document data including the information on the object ID “001” that corresponds to the applied object 45B from the server 3. The document synchronization unit 21 of the terminal 2A changes the object 42A corresponding to the object ID “001” in accordance with the acquired document data 41A. As a result, as illustrated in the example of “26 SECONDS” in FIG. 14, the position of the object 42A is changed to the lower right portion of the screen. The document data 41A to which both the first operation and the second operation are applied is displayed on the screen of the display device 4. Thus, the document data 41A and the document data 41B are synchronized.

[Example of Hardware Configuration of Operation Support Device]

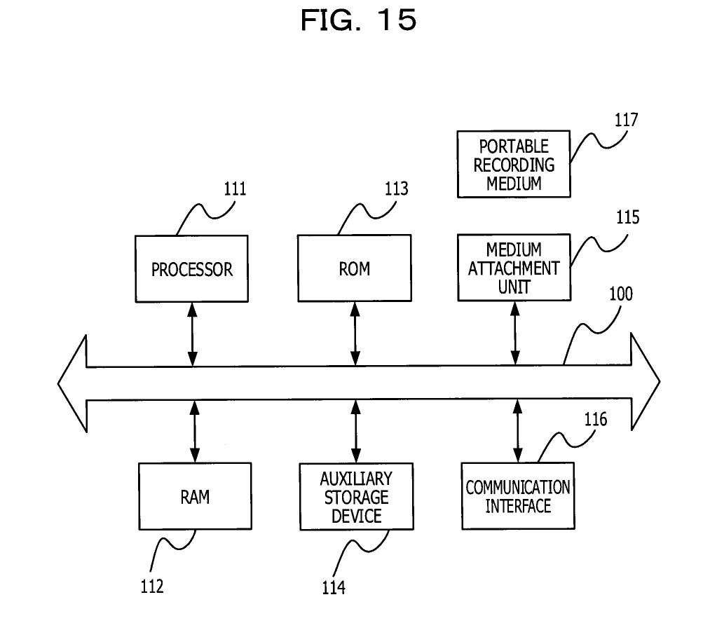

Referring now to FIG. 15, an example of a hardware configuration of the operation support device is described. As illustrated in the example in FIG. 15, a processor 111, random access memory (RAM) 112, read only memory (ROM) 113, an auxiliary storage device 114, a medium attachment unit 115, and a communication interface 116 are coupled to a bus 100.

The processor 111 is a given processing circuit, such as a central processing unit (CPU). The processor 111 executes a program expanded in the RAM 112. The operation support program according to the embodiment may be applied as the program to be executed. The ROM 113 is a nonvolatile storage device, which stores the program expanded in the RAM 112.

The auxiliary storage device 114 is a storage device that stores various kinds of information, and for example, a hard disk drive or semiconductor memory may be applied as the auxiliary storage device 114. The medium attachment unit 115 is arranged so that the medium attachment unit 115 may be coupled to a portable recording medium 117.

Portable memory or an optical disc, such as a compact disc (CD) or a digital versatile disc (DVD), may be applied as the portable recording medium 117. The operation support program according to the embodiment may be recorded in the portable recording medium 117.

The communication interface 116 is an interface used in communicating with the outside. For example, the terminal communication unit 29 may be implemented by the communication interface 116. The storage unit 26 may be stored in the auxiliary storage device 114 or the RAM 112. In the terminal 2 in the example in FIG. 2, the units other than the storage unit 26 and the terminal communication unit 29 may be implemented by the processor 111.

Each of the RAM 112, the ROM 113, and the auxiliary storage device 114 is an example of a computer-readable tangible storage medium. Such tangible storage media are no temporary media, such as signal carrier waves.

[Others]

In the above-described embodiment, the conflict determination unit 24 determines the presence or absence of a conflict. When the first operation and the second operation conflict, the operation that has been started earlier may be enabled and the operation that has been started later may be banned.

Even when the first operation and the second operation conflict, at least the operation that has been started earlier may avoid becoming useless by enabling the operation that has been started earlier instead of banning the operations unconditionally.

Further, when the first operation and the second operation conflict, any one of the terminal 2A and the terminal 2B may replicate the target object of the operation and generate a new object. After that, the first operation may be applied to the original object of the replication and the second operation may be applied to the new object obtained after the replication. As a result, the first operation and the second operation do not become useless.

The operations for an object include deletion operation. For example, while the text input operation as the first operation is being performed on the object 32A at the terminal 2A, the deletion operation could possibly be performed on the object 32B identical to the object 32A at the other terminal 2B.

The first operation at the terminal 2A is applied one by one to the object 32B displayed at the other terminal 2B. Thus, since the user who operates the other terminal 2B visually recognizes that the operation is being performed at the terminal 2A, the user who operates the other terminal 2B is highly likely not to delete the object 32B.

However, there is a possibility that the deletion operation is performed at the other terminal 2B. In this case, the other terminal 2B may disable the deletion operation. After that, the deletion operation of the object 32B may be enabled when the first operation stops being performed at the terminal 2A.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer readable medium having a computer program recorded thereon, the computer program configured to perform a method when executed on a computer, the method comprising:
acquiring first operation information to perform a first operation on an object data at a first device;
acquiring second operation information to perform a second operation on the object data at a second device;
determining whether second display data of the second operation is to be displayed, based on a compatibility between the first operation and the second operation; and
outputting, to an interface, the second display data of the second operation along with first display data of the first operation when the second display data is determined to be displayed.

2. The non-transitory computer readable medium according to claim 1, wherein the method further comprises:
determining, for a combination of the first operation information and the second operation information, whether or not the second display data is to be displayed at the first device by referring to attribute information that indicates whether or not operability is influenced, the attribute information being determined based on whether operability of the first operation is influenced by the second operation.

3. The non-transitory computer readable medium according to claim 1, wherein the method further comprises generating the second display data by
replicating the first display data, and
generating the second display data by applying the second operation to the replicated first display data.

4. The non-transitory computer readable medium according to claim 1, wherein the method further comprises generating the second display data in a manner different from the first display data.

5. The non-transitory computer readable medium according to claim 1, wherein the method further comprises generating the second display data different from the first display data in relation to at least one of transparencies and hues.

6. The non-transitory computer readable medium according to claim 1, wherein the method further comprises generating the second display data with character information when the second operation is performed outside a display of the first device.

7. The non-transitory computer readable medium according to claim 1, wherein the method further comprises:
in a case when the second operation includes operation of enlarging or reducing an object at the second device, displaying the enlarged or reduced object at the first device.

8. The non-transitory computer readable medium according to claim 1, wherein the method further comprises outputting only the first display data of the first operation to the interface, when the first operation is incompatible with the second operation during the performance of the second operation at the second device.

9. A system comprising:
circuitry configured to:
acquire first operation information to perform a first operation on an object data at a first device;
acquire second operation information to perform a second operation on the object data at a second device;
determine whether second display data of the second operation is to be displayed, based on a compatibility between the first operation and the second operation; and
output to an interface, the second display data of the second operation along with first display data of the first operation when the second display data is determined to be displayed.

10. The system according to claim 9, wherein the circuitry is configured to:
determine, for a combination of the first operation information and the second operation information, whether or not the second display data is to be displayed at the first device by referring to attribute information that indicates whether or not operability is influenced, the attribute information being determined based on whether operability of the first operation is influenced by the second operation.

11. The system according to claim 9, wherein the circuitry is configured to generate the second display data by
replicating the first display data, and
generating the second display data by applying the second operation to the replicated first display data.

12. The system according to claim 9, wherein the circuitry is configured to generate the second display data in a manner different from the first display data.

13. The system according to claim 9, wherein the circuitry is configured to generate the second display data different from the first display data in relation to at least one of transparencies and hues.

14. The system according to claim 9, wherein the circuitry is configured to generate the second display data with character information when the second operation is performed outside a display of the first device.

15. The system according to claim 9, wherein in a case when the second operation includes operation of enlarging or reducing an object at the second device, the circuitry is configured to display the enlarged or reduced object at the first device.

16. The system according to claim 9, wherein the circuitry is configured to output only the first display data of the first operation to the interface, when the first operation is incompatible with the second operation during the performance of the second operation at the second device.

17. The system according to claim 9, further comprising:
a server apparatus including the circuitry, wherein the first device is configured to perform the first operation; and
the second device is configured to perform the second operation.

18. A method comprising:
acquiring, by circuitry, first operation information to perform a first operation on an object data at a first device;
acquiring, by the circuitry, second operation information to perform a second operation on the object data at a second device;
determining, by the circuitry, whether second display data of the second operation is to be displayed, based on a compatibility between the first operation and the second operation; and
outputting, by the circuitry, to an interface, the second display data of the second operation along with first display data of the first operation when the second display data is determined to be displayed.

19. The method according to claim 18, wherein
the determining includes determining, for a combination of the first operation information and the second operation information, whether or not the second display data is to be displayed at the first device by referring to attribute information that indicates whether or not operability is influenced, the attribute information being determined based on whether operability of the first operation is influenced by the second operation.

20. The method according to claim 18, wherein the second display data is generated by
replicating the first display data; and
generating the second display data by applying the second operation to the replicated first display data.
